(19) United States
(12) Patent Application Publication
(10) Pub. No.: US 2003/0124497 A1
(43) Pub. Date: Jul. 3, 2003

(54) Personality assessment method

(76) Inventor: Daniel W. Weeks, Des Moines, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 10/034,820

(22) Filed: Dec. 27, 2001

(51) Int. Cl. G09B 19/00

(52) U.S. Cl. 434/236

(57) ABSTRACT

A method and system is provided for identifying and assessing a person's personality characteristics. The method preferably involves a subject, one or more objects created by the subject, an assessment group, and a facilitator. During an assessment session, the group generates descriptions of the objects. Those descriptions are then organized into associative groups that typically reveal certain common threads, themes and/or repeating patterns about the subject.

### FIELD OF THE INVENTION

The present invention relates to the field of personality assessment, and in particular to a method of identifying a subject's talents, strengths, abilities and other personality characteristics through examination of objects created by the subject.

### BACKGROUND OF THE INVENTION

Numerous methods exist for the assessment of personality types and characteristics. These methods are typically used to determine a person's suitability for a particular job or career path, or to help that person gain insight and/or self-awareness that can be used to increase their personal and professional effectiveness. These methods usually involve the subject taking a test of some sort, being interviewed, or in some cases playing a game or even drawing pictures. The result of these assessments is typically a categorization of the subject into one of a finite number of personality “types”.

One of the better known personality assessment tools used today is the Myers-Briggs Type Indicator developed by Katherine Briggs and her daughter Isabel Briggs-Myers around 1930. The Myers-Briggs personality assessment is administered by having the subject answer a number of multiple-choice questions. Based on the answers given to those questions, the subject's personality type is categorized into one of 16 different groups.

A number of patents exist which describe other methods for assessing personality characteristics. For example, U.S. Pat. No. 6,159,015 issued to Buffington, et al, describes a method of personality assessment utilizing sets of multiple-choice questions and word selections. U.S. Pat. No. 4,627,818 issued to Von Fellenberg describes another personality assessment method wherein the subject is required to answer multiple-choice type questions. U.S. Pat. No. 5,795,155 issued to Morrel-Samuels involves a leadership trait assessment method wherein the subject is asked to rank statements directed toward a characteristic of the subject by manipulating movable objects. Rankings of the statements are then used to assess the subject's leadership style. In each of the above methods, the subject is required to in some way answer a set of questions that can then be used to determine certain characteristics and/or traits of the subject. In each case, the end result is the subject being categorized into one of a finite number of personality (or leadership) types.

None of the above methods take into consideration any of the subject's past work, creations, or successes. Also, because each of the above methods is designed specifically to measure a predefined set of characteristics or traits, they cannot, by design, assess traits or strengths that lie outside that predefined set.

A primary objective of the present invention is to provide a method of personality assessment that does not categorize the subject into one of a finite number of personality types, and thereby provides an assessment that is uniquely tailored to the subject.

Another primary objective of the present invention is to provide a method of personality assessment wherein the measured personality characteristics or traits do not belong to a predefined set of characteristics to be measured, therefore allowing any and all relevant characteristics or traits of the subject to be discovered.

Another primary objective of the present invention is to provide a method of personality assessment wherein the subject's characteristics are described without any sort of test being administered to the subject.

Yet another primary objective of the present invention is to provide a method of personality assessment that captures information from the subject's past achievements, successes, and creations.

These as well as other objectives, features, and advantages of the present invention will become apparent from the following additional disclosure.

### BRIEF SUMMARY OF THE INVENTION

The present invention is a method and system for identifying and assessing a person's unique and intrinsic characteristics, traits, talents, strengths, abilities and/or resources. The method typically involves a subject—the person whose characteristics are to be assessed—one or more objects created by the subject, a group of people to participate in the assessment, and a facilitator. The present invention may be performed during a meeting, or assessment session, attended by the subject, the group, and a facilitator. During that session the group generates words and phrases to describe the objects created and brought by the subject, and those descriptive words and phrases are then organized into groups or clusters. Observation of the resulting clusters of descriptions invariably reveals to the subject certain common, repeating themes that exist throughout the subject's personal and/or professional life that can be enlightening and useful to the subject in his or her quest for future success, achievement and happiness in life.

In a preferred form of the present invention, a number of follow-up coaching sessions between the subject and the facilitator can follow the initial assessment session.

The present invention is loosely based on the branch of anthropology known as ethnography, which deals with the scientific description of specific human cultures. Ethnographers investigate all aspects of a culture, including food, shelter, dress, transportation, customs, religion, art, ceremonies, etc., in an effort to identify interrelationships between the individual and the family, clan, tribe, and other groups that may exist within a society. Ethnographers observe and describe, carefully avoiding judgement or explanation; then look for patterns in their descriptive data. The patterns provide insight into the structure and values of the culture, and how it functions.

Similarly, in the present invention, artifacts of the subject's life and work are examined by the assessing group to identify interrelationships and common themes that may exist- and for the resulting insights into the structure and values of the subject. Many trials of this method have shown that it consistently yields valuable and often surprising insights for the subjects. The results show how a person's talents, strengths, abilities and resources have combined in unique but predictable ways to produce past achievements. The results further show how the subject can use these same patterns in the future to meet new challenges and achieve further success. In addition, the results may guide the subject in making decisions about career and life options, helping the subject choose paths for which his or her patterns of achievement make the subject particularly well suited to follow.

### BRIEF DESCRIPTION OF THE DRAWINGS

The present invention is illustrated by way of example and not limitation in the accompanying drawings, and in which:

FIG. 1 symbolically illustrates one or more items created by the subject and brought to the assessment session for examination.

FIG. 2 illustrates unorganized slips of paper having descriptive words written on them.

FIG. 3 illustrates the slips of paper after they have been organized.

FIG. 4 lists descriptive words and phrases generated during an actual assessment session.

Those skilled in the art will recognize additional aspects of the present invention from a detailed description of an exemplary embodiment that follows.

### DETAILED DESCRIPTION OF THE INVENTION

The present invention will be described as it applies to a preferred embodiment. It is not intended that the present invention be limited to the described embodiment. It is intended that the invention cover all modifications and alternatives which may be included within the spirit and broad scope of the invention.

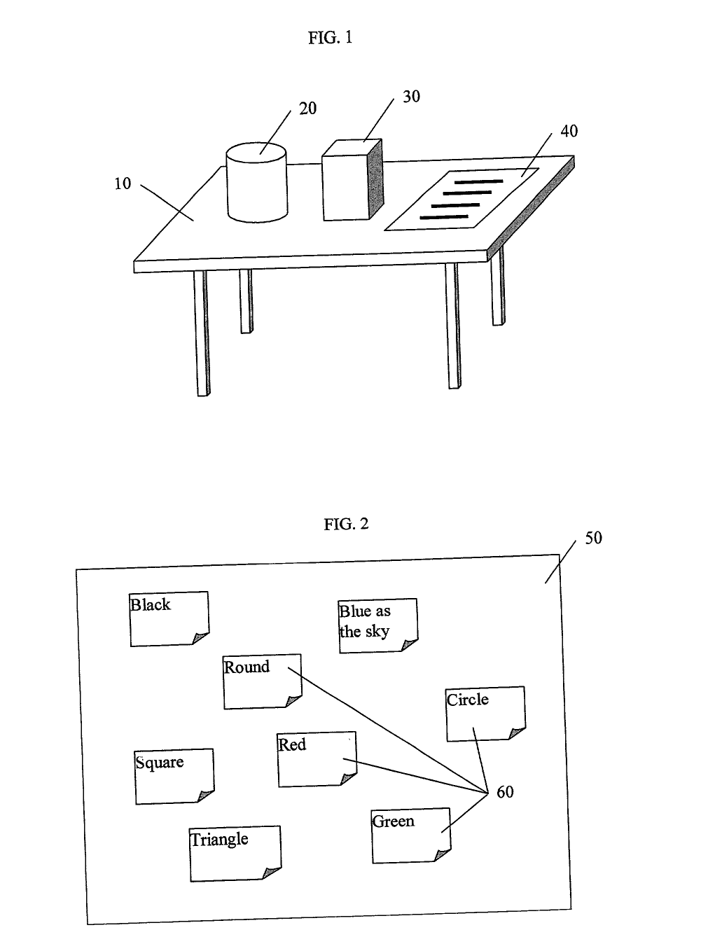

The preferred embodiment of the present invention and its advantages are best understood by referring to FIGS. 1-4 of the drawings. To conduct an assessment on a subject, the subject is first asked to identify three to six people to invite to the assessment session. In the preferred embodiment, these people are friends, family, or co-workers of the subject. While it is possible to conduct the assessment with only the process facilitator, and no group at all, or with a group of strangers, it is preferred to use a group of people familiar to the subject. This provides a conducive, warm and comfortable environment for all involved in which to perform the assessment. Likewise, it would be possible to use any number of people to act as the group, but it has been found that a group of three to six people works best. The people identified by the subject are then invited to attend and participate in the assessment session.

The subject is also asked to bring to the assessment session three objects that he or she has created. It is left to the subject to determine what objects should be brought. Typically, the subject will bring objects that have great significance to him or her, highlighting an achievement and/or reflecting a cherished skill. For example, people who have been assessed using the present invention have brought items such as songs they have written, cookies they have made, poems, woodworking, gadgets, etc.

It should be understood that the number of objects can vary. However, it has been found that three objects provided works well in most sessions.

The assessment session is attended by the subject and by the group of people invited by the subject. It is orchestrated and run by the process facilitator. The facilitator starts the session by giving an overview, explaining the concept of the process and its goals. The participants are then asked to introduce themselves. Following the introductions, the facilitator asks the subject a number of open-ended questions. These questions help set the stage for discussions that occur near the end of the session. The three preferred open-ended questions are:

1) Who are you?

2) What is your highest value?

3) What is your current greatest professional challenge?

The facilitator will make either a written or mental note of the subject's responses to these questions.

At this point in the process, the facilitator gives the group instructions on what they are to do. The group is given the analogy of being anthropologists dropped into the jungle to study an unknown tribe. The facilitator tells the group that they are to observe the three objects brought by the subject and generate one-word or short phrases to describe the objects. FIG. 1 shows symbolic representations of three objects 20, 30 and 40 sitting on a table 10. The objects 20, 30, 40 can be virtually anything that the subject has created, including written material as is indicated by item 40. The descriptions that the group is to generate can apply to one, two or all three of the objects. The descriptions should be descriptive only, and not explanatory, evaluative, or qualitative or in any other way judgmental. The descriptions can come in any order and no explanations of the descriptions are needed at this time.

One person is assigned the responsibility of writing down the descriptive words and phrases onto small pieces of paper or “sticky-notes” (e.g., Post-It brand notes). FIG. 2 illustrates these slips of paper with descriptions 60. As they are generated, the papers are placed on a bulletin board or wall 50 for all to see. Likewise, the descriptions generated could be entered into and displayed on a computer, rather than using pieces of paper. During this phase of the process, the subject may choose to participate in generating descriptive words or phrases, or may choose to simply listen and watch.

There is no set time limit to this descriptive-word-generating session. It will typically generate 100 to 200 slips of paper with descriptions 60 and have a “lull” near the end when the generation of descriptions slows dramatically. The facilitator helps manage this process, encouraging the group to keep thinking during this “lull” to provide additional descriptions. Once the facilitator determines that a sufficient number of descriptions have been recorded, the facilitator then moves the group on to the next phase of the process.

At the beginning of this next phase of the process, the facilitator or the group, by turns, read aloud all the descriptive words and phrases to the group and the subject. This provides a break in the process for all the participants and allows them to relax and let the words sink in. The facilitator will then work with the subject and the group to clarify or eliminate any redundant or ambiguous words until everyone agrees and accepts all the words as meaning what they were intended to mean.

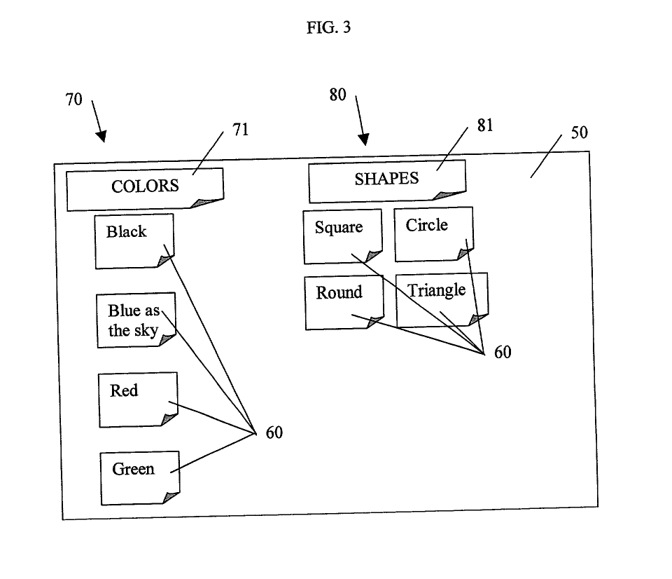

The facilitator will then ask the subject a few questions: What do you think? Do the words describe your object? Anything surprising? The facilitator will then ask the group if any of the words go together. He or she will then invite all the participants to rearrange the slips of paper 60 on wall 50 so that they are organized into associative clusters. The organization or clustering process is not guided by the facilitator, and is a collaborative process. FIG. 3 illustrates the slips of paper 60 after having been rearranged into such clusters 70, 80. As shown in FIG. 3, both clusters 70, 80 have been given names or labels 71, 81 to identify them. The cluster labels 71, 81 are shown in FIG. 3 as having been written on pieces of paper of a different size than the other papers 60. This is done to help differentiate the labels 71, 81 from the other descriptive words. This could also be done using different colored paper, different colored ink, or some other method.

In the next step, the facilitator describes the situation and reviews the clusters that have been created. The facilitator then asks the subject: “Do any of these clusters have any special meaning with you? Do any of them resonate with experiences you have had? Do any of them have importance to you?” The facilitator will then ask the subject to pick out up to three of the “resonant clusters” and to tell a story to the group about their earliest experience which has a connection to the resonant cluster.

In trials of this method the subject has typically at this point related a story from their adolescence or preadulthood, indicating that the resonance indeed goes back to a fairly early point in their life. The subject will often have an “aha” type experience either before or during the telling of their story, in which they will suddenly grasp some new insight or significance in the resonant cluster as it relates to their life. The common thread, theme, or repeating pattern can be recorded, either by hand or with the aid of a device or machine, such as a computer. This “aha” experience may be a profound and/or emotional one for the subject, as it reveals a significant insight into some common thread or theme or repeating pattern in their life. The “aha” often reveals sources of strength, courage, creativity or other resources that the subject has or has used in the past, but which they have forgotten or have not been fully conscious of, which can be tapped in the future to tackle new obstacles.

Once the “aha” has occurred, the facilitator can then begin to probe a little deeper, asking how the subject has used the resonant theme in the past to achieve success, reminding the subject of their current greatest professional challenge and how it could be helped by their new insight.

Follow-up coaching sessions between the process facilitator and the subject may be held to help the subject fully appreciate and understand the information revealed during the assessment session, and to incorporate and utilize that knowledge to achieve greater success and happiness in their professional and their personal life.

Fully developing and realizing the potential of the information generated during the assessment session can take a significant amount of time. Trials of the present invention typically involved three or more one-on-one coaching sessions between the facilitator and the subject that extended over several months. This time was used to more completely define and understand the recurring themes that were discovered during the assessment session, and to develop plans for applying the new knowledge in the subject's life.

### EXAMPLE

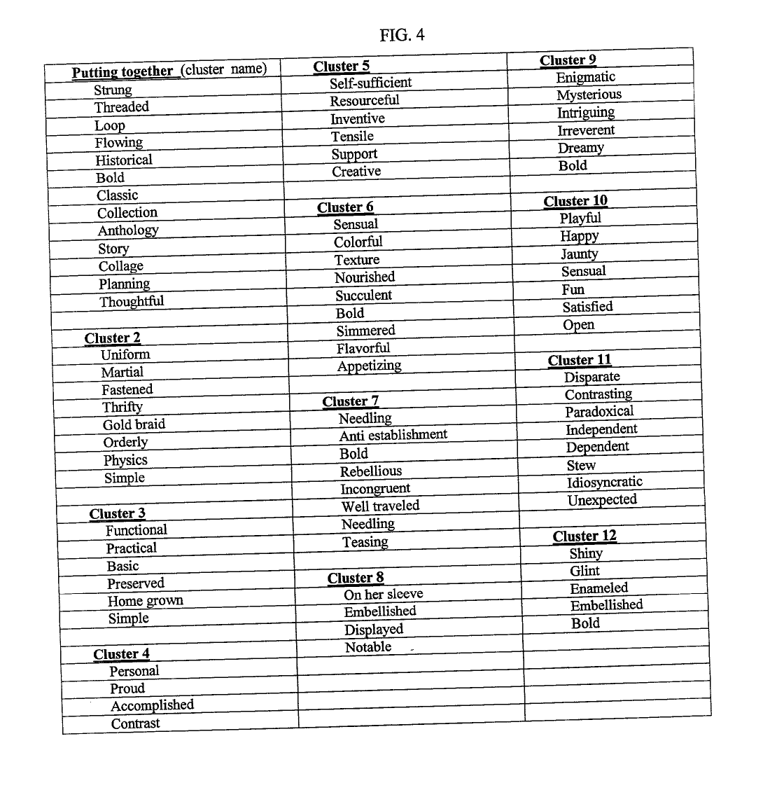

FIG. 4 shows a list of descriptive words generated during a trial of the present invention. In this example, the three items that were brought were a jacket that had been made by the subject, an invention created by the subject that consisted of several foot-long pieces of string and some fasteners, and a baggie containing a frozen stew-like concoction of vegetables and spices. As can be seen in FIG. 4, the assessment group generated approximately 80 descriptions that were then grouped into twelve clusters, one of which was named “putting together”.

A general description of the present invention as well as a preferred embodiment of the invention has been set forth above. Those skilled in the art to which the present invention pertains will recognize and be able to practice additional variations in the methods described and disclosed which fall within the teachings of this invention. Accordingly, all such modifications and additions are deemed to be within the scope of the invention, which is only limited by the claims.

What is claimed is:

1. A new method for assessing the personality characteristics of a subject comprising the steps of:
a. examining at least one object created by said subject;
b. generating one or more descriptions of said object;
c. arranging said descriptions into associative groups; and
d. presenting said arrangements of descriptions to said subject, whereby said arrangements reveal to said subject certain underlying themes in his or her life.

2. The method of claim 1 wherein at least three objects created by said subject are examined and described.

3. The method of claim 1 wherein said examination of said object, said generation of said descriptions and said arrangement of said descriptions is performed by at least one person.

4. The method of claim 1 wherein said examination of said objects, said generation of said descriptions and said arrangement of said descriptions is performed by a group of people.

5. The method of claim 1 wherein said descriptions consists of single words and or phrases that describe said object.

6. The method of claim 1 further comprising the step of recording the themes.

7. A new method for assessing the personality characteristics of a subject that is uniquely tailored to the subject, the method comprising:
selecting two or more persons familiar with the subject to act as an accessing group;
providing one or more objects created by the subject;
examining the one or more objects;
generating one or more descriptions for the one or more objects;
clustering the one or more descriptions into associative categories; and
disclosing the categories to the subject, whereby the categories reveal common threads, themes or repeating patterns about the personality characteristics of the subject.

8. The method of claim 7 wherein the assessing group examines the one or more object and generates the one or more descriptions.

9. The method of claim 8 wherein the assessing group clusters the descriptions into associative categories.

10. The method of claim 7 wherein the method is performed as part of an assessment session.

11. The method of claim 10 wherein the assessment session is lead by a facilitator.

12. The method of claim 11 further comprising conducting follow-up sessions between the subject and the facilitator to further examine and discuss the common threads, themes or repeating patterns in the subject's life.
